(19) United States
(12) Patent Application Publication
(10) Pub. No.: US 2015/0347455 A1
(43) Pub. Date: Dec. 3, 2015

(54) REPRESENTING A VENUE

(71) Applicant: Apple Inc., Cupertino, CA (US)

(72) Inventors: Philip Stanger, Cupertino, CA (US); Ian Aric Mondragon, Cupertino, CA (US); David C. Lo, Fremont, CA (US); Ashish Agarwal, Sunnyvale, CA (US); Vojislav Samsalovic, Saratoga, CA (US); Stephanie May Cowles, San Francisco, CA (US)

(21) Appl. No.: 14/726,382

(22) Filed: May 29, 2015

Related U.S. Application Data
(60) Provisional application No. 62/005,911, filed on May 30, 2014.

(51) Int. Cl. G06F 17/30; H04W 4/04; G01S 5/00

(52) U.S. Cl. CPC G06F 17/30221; G01S 5/0045; H04W 4/043

(57) ABSTRACT

Techniques for storing information representing a venue are described. A system can represent a venue as a set of one or more nested data objects. A top layer of the nested data objects can include a venue data object that stores coarse information of the venue, including an identifier, a name, and a geometry of the venue. A second layer of data objects that are nested in the venue data object can include one or more building data objects that have finer granularity than the venue data object. Each building data object can store information on a building located at the venue, including name of the building, address of the building, and a geometry of the building. Additional layers of data objects representing further details of each building.

### CROSS-REFERENCE TO RELATED APPLICATIONS

This application claims priority to U.S. Provisional Patent Application No. 62/005,911, entitled “Representing a Venue,” filed on May 30, 2014, the entire contents of which is incorporated herein by reference.

### TECHNICAL FIELD

This disclosure relates generally to location-based services.

### BACKGROUND

Some mobile devices have features for determining a geographic location. For example, a mobile device can include a receiver for receiving signals from a global satellite system (e.g., global positioning system or GPS). The mobile device can determine a geographic location, including latitude and longitude, using the received GPS signals. The mobile device can then display the geographic location on a virtual map on a display screen. The virtual map can be stored in various data formats. The mobile device may visit a venue that includes indoor space. Data formats that are suitable for outdoor maps may not be suitable for storing maps representing the indoor space.

### SUMMARY

Techniques for storing information representing a venue are described. A system can represent a venue as a set of one or more nested data objects. A top layer of the nested data objects can include a venue data object that stores coarse information of the venue, including an identifier, a name, and geometry of the venue. A second layer of data objects that are nested in the venue data object can include one or more building data objects that have finer granularity than the venue data object. Each building data object can store information on a building located at the venue, including name of the building, address of the building, and a geometry of the building. Additional layers of data objects representing further details of each building, including, for example, each level of the building, each unit on a level, and each occupant in each unit can be nested in each building data object. Each data object can be a JavaScript object notation (JSON) compatible data object.

The features described in this specification can be implemented to achieve one or more advantages. Compared to conventional map data formats, the techniques described in this specification are more suitable for representing indoor features. Information related to indoor space, e.g., companies located on each floor of a building, can be integrated in the nested data object representation. Such representations can be easier for a mobile device to handle than, for example, data generated using computer-aided design (CAD) software. Maps generated using the nested data objects can be used by a mobile device to display a location of the mobile device in the venue.

The details of one or more implementations of the subject matter are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an exemplary system providing venue services.

FIG. 2 is a block diagram illustrating an exemplary structure of a file storing venue data.

FIG. 3A illustrates an exemplary user interface for selecting a building to perform location survey using data representing one or more venues.

FIG. 3B illustrates an exemplary user interface for starting a location survey at a venue.

FIG. 4 illustrates an exemplary user interface for displaying an estimated location of a user device in a venue.

FIG. 5 is a block diagram illustrating components of an exemplary venue subsystem of a location server.

FIG. 6 is a flowchart of an exemplary process of storing venue information.

FIG. 7 is a block diagram of an exemplary system architecture for implementing the features and operations of FIGS. 1-6.

Like reference symbols in the various drawings indicate like elements.

### DETAILED DESCRIPTION

### Exemplary Venue File Data Format

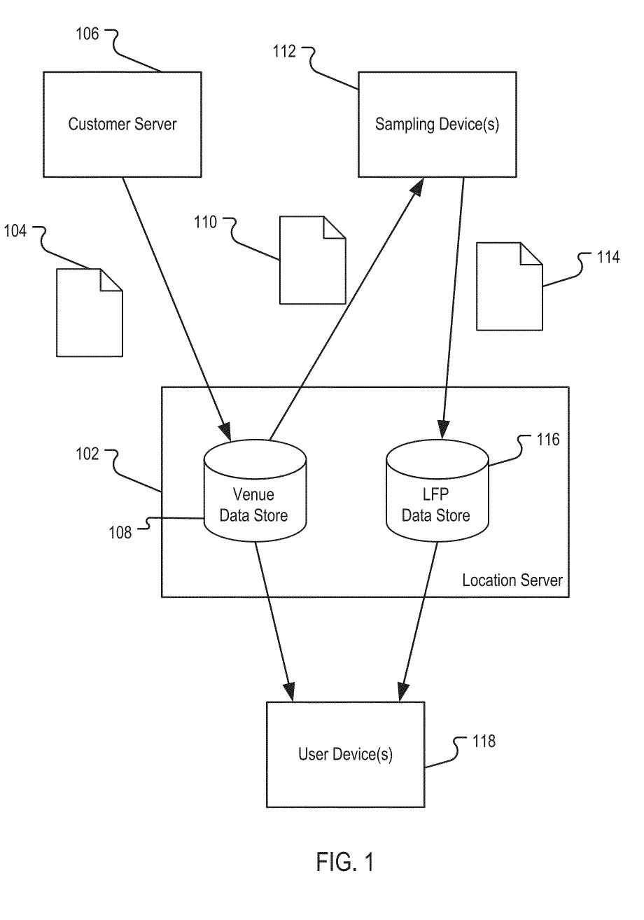

FIG. 1 is a diagram illustrating exemplary system providing venue services.

Location server 102 can receive venue information 104 from customer server 106. Customer server 106 can be a computing device operated by a data provider. Venue information 104 can be in various formats.

Location server 102 can store location information as venue data in venue data store 108. Venue data can include a file having a JSON data format conforming to a standard of the European Computer Manufacturers Association (ECMA). An example of the standard is Standard ECMA-404. Each object or destination in the document can be described in a language specified in a Language Code attribute of the document, using nested layers of attributes.

The objects and destinations in the file can be organized in one or more tree structures. General aggregations of these structures can be designated as “layers.” Each layer can be nested within a layer before it. Layer A is nested in layer B if an object in layer A includes an identifier referencing an object in layer B. The layers can include the following.

Venue
Building
Level
Unit
Opening
Roadway
Section
Point (point of interest)
Detail
Fixture
Occupant

In addition, each object in a layer can be associated with metadata. The metadata can include an “Address” data object, which will be described in additional detail below. In some implementations, layers are associated with one another rather than being nested within one another.

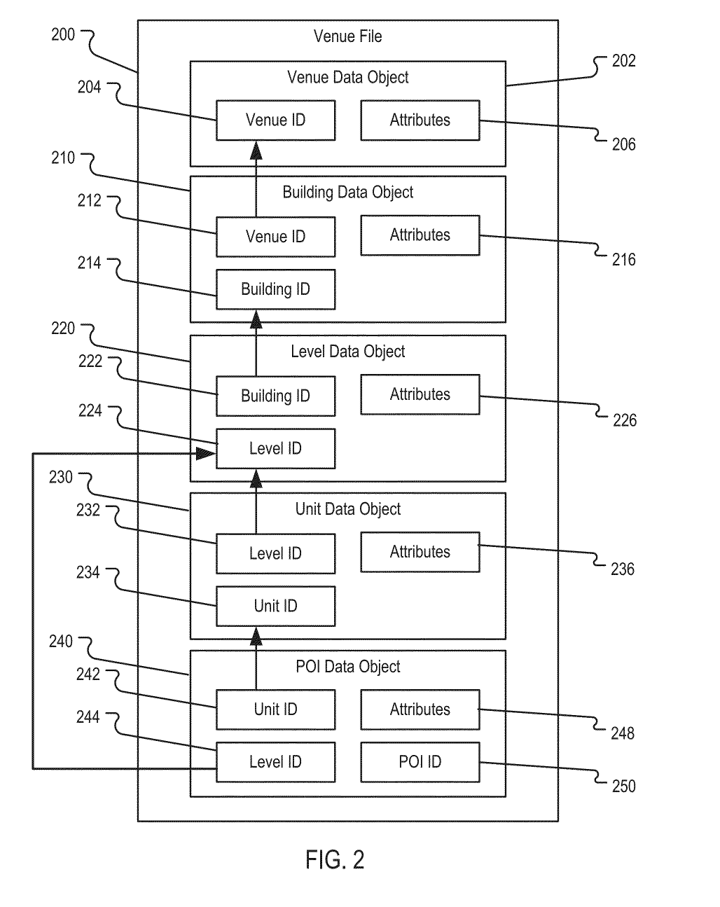

Additional details of a structure of the file and a structure of each data object will be described below in reference to FIG. 2. Location server 102 can provide venue data 110 to one or more sampling devices 112 to perform a location survey of the venue as represented by venue data 110. The survey can include measuring environmental variables, e.g., wireless signal strengths, at various locations in the venue. Location server 102 can receive survey data 114 from sampling device 112. The survey data 114 can include the measurements and corresponding locations where the measurements are taken. Location server 102 can generate location fingerprint data and store the location fingerprint data in location fingerprint data store 116. The location fingerprint data can include expected signal measurements at various locations in the venue, and can be used by one or more user devices 118 to determine a location in the venue.

User device 118 can be a mobile device, e.g., a smartphone or tablet computer. User device 118 can request venue data and location fingerprint data from location server 102. Location server 102 can provide venue data 110, or a map of a venue generated based on venue data 110, to user device 118. Location server 102 can provide location fingerprint data for that venue to user device 118. User device 118 can determine an estimated location of user device 118 in the venue, and display the location on a map generated by user device 118 from the venue data 110 or other map.

FIG. 2 is a block diagram illustrating an exemplary structure of a file 200 storing venue data. File 200 can include a series of one or more data objects representing various features of a venue. The data objects are nested in multiple layers. File 200 can be stored as a single file having multiple sections, or as separate files. If stored in separate files, each file can correspond to a different layer or type.

File 200 can include venue data object 202. Venue data object 202 can be an object in a highest-level layer, the Venue layer. A venue data object can represent a venue, e.g., a university or corporate campus, an industrial complex, a shopping center or airport, a museum or resort. Venue data object 202 can have a venue geometry and a set of one or more properties.

The venue geometry can be polygon defined by geographic coordinates that translate to physical locations or zones of property on the surface of the Earth based on the WGS84 datum. The polygon can be a representation of an outer boundary of the venue. The GEOMETRY property represents a geometry of the venue. When the venue is bound by surface streets, the geometry can extend to a centerline of a nearest carriageway bounding the outermost structures including the venue. When the venue is not defined by a street, the geometry can extend to a parcel boundary of the venue, or equivalent. The venue geometry can exclude buildings or other areas that are not part of the venue. The venue geometry can completely contain all other geometries associated with the venue.

The set of one or more properties can be stored in various data fields. These data fields can include venue identifier data field 204 storing an identifier of the venue, and one or more attribute data fields 206 for storing various properties of the venue. The properties can include geographic attributes of the venue. Venue data object 202 can include the following properties as shown in Listing 1. Each property can be stored in a separate data field of venue data object 202.

Listing 1: Venue Data Object Format

| Property | Required | Type | Description |
|---|---|---|---|
| VENUE_ID | Yes | String | A unique identifier for a venue |
| NAME | Yes | String | A name of the venue |
| CATEGORY | Yes | String | A category identifier reference |
| PHONE | Yes | String | Primary phone number for the |
| | | | venue, can be in E.164 format |
| WEBSITE | Yes (Optional in | String | An official website URL for |
| | some | | the venue. If occupant(s) of |
| | implementations) | | the venue has no website, |
| | | | value of this property can be |
| | | | undefined. |
| ADDRESS_ID | Optional | String | Unique identifier of an |
| | | | Address data object of this |
| | | | venue |
| SOURCE | Optional | Point | Description of the source or |
| | | | sources used to derive the |
| | | | features and properties |

In some implementations, the CATEGORY can be one of the following.

Airport
Aquarium
Business Campus
Casino
Community Center
Government Facility
Healthcare Facility
Hotel
Museum
Parking Structure
Private Office
Resort
Retail Store
Shopping Center
Stadium
Theater
Theme Park
Transit Station
University

The name of each property listed in Listing 1 and subsequent listings are chosen for conveniently conveying a meaning of the respective property. In various implementations, different names can be used for the properties. For example, the names “a,” “b,” and “c” can be used in place of “VENUE_ID,” “NAME,” and “GEOMETRY.”

An example of venue data object 202 is provided as follows in Listing 2. Coordinates in “geometry” are omitted.

Listing 2

{

| “type”: “FeatureCollection”, | |
|---|---|
| “features”: [ { | “type”: “Feature”, “properties”: { |

“VENUE_ID”: “SN1US37637”,
“NAME”: “Westfield San Francisco Center”,
“CATEGORY”: “Shopping Center”,
“SOURCE”: “CAD”,
“PHONE”: “+16505551234”,
“WEBSITE”: “http://www.abc.com/”,
“ADDRESS_ID”: “001”,
“HOURS”: “Mo-Sa 10:00-20:30; Su 10:00-19:00”
},

“geometry”: { “type”: “Polygon”, “coordinates”: [ [ ... ] ] }
} ]

}

File 200 can include one or more building data objects 210. Each building data object 210 is in a second layer, a Building layer, that is one level lower than the venue layer. Each building data object 210 can represent a building at a venue. Each building data object 210 can include building geometry 211 and a building property set containing one or more building features.

Building geometry 211 can be a polygon or multi-polygon in geographic coordinates representing the overhead or orthogonal exterior outline of a structure with interior space that is open to visitors. Each building polygon can be contained within the Venue polygon. All buildings associated with a venue can be captured in the building property set, unless the building has no public access. Building geometry can capture all building elements visible from above the roof, including overhangs, balconies, and elements of the building facade. Underground levels can be excluded from the building geometry. An underground structure, e.g., a subway station can be represented in the building geometry only as the above ground portion, such as an entrance. Where these portions are not continuous, the building can be represented as a multi-polygon. Adjoining structures under different ownership or occupancy, or with different conventions of how levels are named, can be captured as separate buildings. Building geometry 211 can indicate that the building represented by building data object 210 is located in, and therefore associated with, a venue represented by venue data object 202.

The building property set can include a venue identifier data reference field 212. Venue identifier data reference field 212 can store a venue identifier referencing a venue in which the building is located. The referencing determines a nesting relationship between building data object 210 and venue data object 202. Each building data object 210 can include a building identifier data field 214 for storing an identifier of the building represented. Each building data object 210 can include one or more attribute data fields 216 for storing various properties of the building. The properties can include geographic attributes of the building. One building data object 210 is shown in file 200. File 200 can include multiple building data objects 210 arranged in a series. Building data object 210 can include the following properties as shown in Listing 3. Each property can be stored in a separate data field of building data object 210.

Listing 3: Building Data Object Format

| Property | Required | Type | Description |
|---|---|---|---|
| BLDG_ID | Yes | String | A unique identifier for a building |
| NAME | Optional | String | A name of the building |
| SOURCE | Yes | String | Description of the source or sources |
| | | | used to derive the features and |
| | | | properties. |
| CATEGORY | Optional | String | A category identifier reference |
| VENUE_ID | Yes | String | An identifier of a venue associated |
| | | | with the building |
| ADDRESS_ID | Optional | String | Unique identifier for the address of |
| | | | this building listed in the Address |
| | | | table |

File 200 can include one or more level data objects 220. Each level data object 220 is in a third layer, a Level layer, that is one level lower than the building layer. Each level data object 220 can represent a level, e.g., a floor or a roof, of a building. Each level data object 220 can include level geometry 221 and a level property set containing one or more properties.

Level geometry 221 can include a closed polygon in geographic coordinates representing an interior level or outdoor public space within a building such as stadium seating or publicly accessible roof. Each level can be represented in geographic coordinates that represent the exterior dimensions of the building(s) through which it is accessed such that the polygons overlap and if there are shared vertices, the vertices can be completely coincident.

A level may contain holes only if the holes represent a significant architectural component that affects the shape of the Building, is visible from overhead, and is consistent through all levels, such as a large inner courtyard. Levels that are not open to the public may be excluded from the level's property set. An open-air area that is open to the public, such as a roof or stadium, can be represented in the level's property set. Levels in different buildings can be separate features. Where a continuous Level spans two buildings, for example below ground or via a skybridge, the level can be split either between the buildings, or in line with one of the building boundaries. A level must include all floor area within a particular building that can be accessed without changing floors. Sections of a floor that are at the same height but are named differently in floor plans and wayfinding maps may be captured in separate buildings or as Sections within the Level.

The level data object 220 can include a building identifier data reference field 222. Building identifier data reference field 222 can store a building identifier referencing a building in which the level is located. The referencing determines a nesting relationship between level data object 220 and building data object 210. Each level data object 220 can include a level identifier data field 224 for storing an identifier of the level represented. Each level data object 220 can include one or more attribute data fields 226 for storing various properties of the level. The attributes can include geographic attributes of the level. One level data object 220 is shown in file 200. File 200 can include multiple level data objects 220 arranged in a series. Level data object 220 can include the following properties as shown in Listing 4.

Listing 4: Level Data Object Format

| Property | Required | Type | Description |
|---|---|---|---|
| LEVEL_ID | Yes | String | An identifier for a level |
| NAME | Optional | String | Name of Level, which may differ |
| | | | from NUMBER (e.g. |
| | | | ″Mezzanine″). Localization |
| | | | selection can be denoted by |
| | | | appending a colon ″:″ followed |
| | | | by internationalization (I18N) |
| | | | localization code, e.g. |
| | | | Mezzanine:en_US |
| CATEGORY | Optional | String | A category identifier reference. |
| | | | Value can be indoor or outdoor. |
| BLDG_IDS | Yes | String | A list of one or more BLDG_IDs |
| | | | associated with this level |
| ORDINAL | Yes | Integer | Integer value identifying a z-level/ |
| | | | stacking order of this Level |
| | | | feature with respect to others |
| | | | within the same Building. Ground |
| | | | level features are at level 0, |
| | | | subterranean levels have negative |
| | | | values, and above ground levels |
| | | | are positive values. For example, |
| | | | a building with one basement |
| | | | level and three floors above |
| | | | ground should have Levels with |
| | | | values [−1, 0, 1, 2] |
| SHORT_NAME | Optional | String | One to four character signifier or |
| | | | abbreviation for the Level shown |
| | | | on elevators or venue directories, |
| | | | e.g., ‘1’, ‘2’, ‘LL’, ‘M’ or ‘C’ |
| SOURCE | Yes | String | Description of the source or |
| | | | sources used to derive the features |
| | | | and properties |

An example of level data object 220 is provided as follows in Listing 5.

Listing 5

{

“type”: “FeatureCollection”,
“features”: [
{ “type”: “Feature”, “properties”: {

“LEVEL_ID”: “002”,
“CATEGORY”: “Indoor”,
“ORDINAL”: 0,
“NAME”: “Level 1”,
“SHORT_NAME”: “1”,
“SOURCE”: “CAD”
},

“geometry”: { “type”: “Polygon”, “coordinates”: [...] } },
{ “type”: “Feature”, “properties”: {

“LEVEL_ID”: “004”,
“CATEGORY”: “Indoor”,
“ORDINAL”: −1,
“NAME”: “Level LC”,
“SHORT_NAME”: “2”,
“SOURCE”: “CAD”
},
“geometry”: { “type”: “Polygon”, “coordinates”:[...] } }

]

}

File 200 can include one or more unit data objects 230. Each unit data object 230 is in a third layer, a Unit layer, that is one level lower than the Level layer. Each unit data object 230 can represent attributes of a unit on a level. Each unit data object 230 can include unit geometry 231 and a unit property set including one or more property of the unit.

Unit geometry 231 can be a closed polygon having geographic coordinates representing a physically distinct substructure or area within a venue, either inside or outside a building. Examples of units include rooms, elevators, escalators, stairs, level changes, and areas “open to below” as well as natural areas, walkways, and parking.

Units may be traced, transformed or digitized from various sources. A LEVEL_ID for an outdoor unit can be the nearest Level at approximately the same height, e.g., the ground floor level. A distinct area with walls or partial walls on three or more sides, such as an exhibit hall or waiting room, can be a unit having CATEGORY “Room.”

The unit data object can be stored in various data fields. The data fields can include a level identifier data reference field 232. Level identifier data reference field 232 can store a level identifier referencing a level on which the unit is located. The referencing determines a nesting relationship between unit data object 230 and level data object 220. Each unit data object 230 can include a unit identifier data field 234 for storing an identifier of the unit represented. Each unit data object 230 can include one or more attribute data fields 236 for storing various properties of the unit. The properties can include geographic attributes of the unit. One unit data object 230 is shown in file 200. File 200 can include multiple unit data objects 230 arranged in a series. Unit data object 230 can include the following properties as shown in Listing 6.

Listing 6: Unit Data Object Format

| Property | Required | Type | Description |
|---|---|---|---|
| UNIT_ID | Yes | String | An identifier for a unit |
| NAME | Optional | String | Name of a unit Localization |
| | | | selection can be denoted by |
| | | | appending a colon ″:″ followed |
| | | | by I18N localization code, e.g. |
| | | | Washroom:en_US |
| CATEGORY | Yes | String | A category identifier reference, |
| | | | e.g., “Elevator,” “Room,” or |
| | | | “Stairs |
| LEVEL_ID | Yes | String | An identifier referencing a level |
| | | | associated with this unit. |
| ADDRESS_ID | Optional | String | Unique identifier for the address |
| | | | of this unit listed in an address |
| | | | table |
| SUITE | Optional | String | The suite, office, store or |
| | | | other reference number associated |
| | | | with the Unit in source materials |
| | | | (e.g. ″234A″). |
| RESTRICTED | Optional | String/ | This access type applies to the |
| | | Boolean | associated Unit and indicates |
| | | | whether the Unit can be accessed |
| | | | by the general public or not. |
| | | | Value can be “Restricted_ |
| | | | employees, Restricted_admission, |
| | | | Restricted_Unknown.” |
| HEIGHT | Optional | Floating | Height of the unit in meters, to the |
| | | Point | nearest tenth of a meter. |

File 200 can include one or more opening data objects. Each opening data object can include an opening geometry and a set of opening features. The opening geometry can be a data object, e.g., a LineString object, that represents a sequence of points and line segments connecting them. The points can be represented in geographic coordinates representing a portion of the edge of two coincident units that allows for visitors to the units to pass between the units. Some example of openings include a doorway or the absence of a wall. End vertices of an opening can coincide, e.g., snap to, vertices in the corresponding Units.

An opening can be traced and georeferenced from floor plans and wayfinding maps based on unit boundaries. Opening can be traced on units with certain CATEGORY, e.g., “Room,” “Restroom,” “Elevator,” “Escalator,” “Stairs,” “Ramp,” or equivalent. Openings such as stairs, escalators or ramps that connect different levels can be assigned different LEVEL_IDs at each end. An opening data object can include multiple data fields for storing an OPENING_ID, a CATEGORY, one or more LEVEL_IDs, RESTRICTED, and SOURCE information, respectively.

File 200 can include one or more roadway data objects. Each roadway data object can include a roadway geometry and a roadway property set containing one or more roadway properties. The roadway geometry can include a LineString data object representing an access road or other publicly accessible roadway within a venue.

Roadways associated with a venue can include all access roads necessary for navigating around the venue. Roadways can be traced along the centerline of the road from a best available source. Roadways associated with a venue can include roads within the venue. Municipal streets around the venue can be excluded from roadways associated with a venue. Large streets running through the venue accessible to through-traffic can be captured as CATEGORY “Municipal Road.” Private roads, airport runways and other roads not open to public motor vehicle traffic can be excluded from roadways. Entrances to parking lots from an access road can be captured as CATEGORY “Parking Access.” Parking aisles can be excluded from roadways.

The roadway data object can include data fields for storing properties listed below in Listing 7.

Listing 7

| Property | Required | Type | Description |
|---|---|---|---|
| ROAD_ID | Yes | String | An identifier for a roadway |
| LEVEL_ID | Yes | String | A unique identifier of a level to |
| | | | which the road is associated |
| NAME | Optional | String | Name of a roadway |
| TWOWAY | Optional | Boolean | Whether the roadway accommodates |
| | | | two way traffic |
| CATEGORY | Yes | String | A category of the roadway |
| SOURCE | Yes | String | Description of the source or sources |
| | | | used to derive the geometry and |
| | | | properties. |

File 200 can include one or more section data objects. A section data object can represent physically distinct subdivision or grouping of units either inside or outside of a building. Examples of sections include named parking sections in very large parking lots, department store departments, casino gaming floor areas, and stadium or large theater seating sections. Each section data object can include a section geometry, which can be a representation of a closed polygon in geographic coordinates.

The section data object can include data fields for storing properties listed below in Listing 8.

Listing 8

| Property | Required | Type | Description |
|---|---|---|---|
| SECTION_ID | Yes | String | An identifier for a section |
| LEVEL_ID | Yes | String | An identifier of a level associated |
| | | | with the section |
| NAME | Yes | String | Name of a roadway |
| SOURCE | Yes | String | Description of the source or sources |
| | | | used to derive the geometry and |
| | | | properties. |

File 200 can include one or more point data objects 240. Each point data object 240, or simply a point data object 240, is in a fifth layer, a point layer, that is one level lower than the Level layer or one level lower than the Unit layer. Each point data object 240 can represent attributes of a point, e.g., a flight gate, associated with a unit or a level. Point data object 240 may represent a public entrance to a building within a value. Each point data object 240 can include a unit identifier data reference field 242. Unit identifier data reference field 242 can store a unit identifier referencing a unit in which the point is located. The referencing determines a nesting relationship between point data object 240 and unit data object 230. Each point data object 240 can include a level identifier reference data field 244. Level identifier data reference field 244 can store a level identifier referencing a level on which the unit is located. The referencing determines a nesting relationship between point data object 240 and level data object 220. Each point data object 240 can include a point identifier data field 250 for storing an identifier of the POI represented. Each point data object 240 can include one or more attribute data fields 248 for storing various properties of the point. The properties can include a location of the point. One point data object 240 is shown in file 200. File 200 can include multiple point data objects 240 arranged in a series. Point data object 240 can include the following properties as shown in Listing 9.

Listing 9: Point Object Format

| Property | Required | Type | Description |
|---|---|---|---|
| POINT_ID | Yes | String | An identifier for a Point |
| NAME | Optional | String | Name of a Point. Localization selection |
| | | | can be denoted by appending a colon ″:″ |
| | | | followed by I18N localization code, e.g. |
| | | | Gate A55:en_US |
| CATEGORY | Yes | String | A category identifier reference, e.g., |
| | | | ATM, Ticketing, or Pay Phone |
| LEVEL_ID | Yes | String | An identifier referencing a level |
| | | | associated with this point |
| SOURCE | Yes | String | Description of the source or sources used |
| | | | to derive the geometry and properties |

File 200 can include one or more detail data objects. Each detail data object can represent one or more permanent, immovable architectural features or other structures within a level such as walls, doorways, shelving units and exhibit displays that are represented as lines and curves on vectorised floor plans that are accurately to scale, such as CAD drawings. A detail data object can include a detail geometry, which can have a LineString type. The detail geometry can represent a contiguous line on a floor plan. A detail data object can have data fields for storing a DETAIL_ID, a CATEGORY, and a LEVEL_ID indicating a level on which the represented detail is located. The CATEGORY can be, for example, Column, Door, or Wall.

File 200 can include one or more fixture data objects. Each fixture data object can represent one or more permanent, immovable architectural features or other structures within a level such as baggage claim areas or water fountains that are represented as polygons. A fixture data object can include a fixture geometry, which can have a Polygon type. The detail geometry can represent a contiguous line on a floor play. A detail data object can have data fields for storing a FIXTURE_ID, a CATEGORY, and a LEVEL_ID indicating a level on which the represented detail is located. The CATEGORY can be, for example, Column, Kiosk, or Wall.

File 200 can include one or more occupant data objects. Each occupant data object can represent attributes of an occupant, e.g., a residential or commercial tenant, associated with a unit. Each occupant data object can include an occupant geometry representing a location of the occupant. Each occupant data object can include a unit identifier reference data field. The unit identifier reference data field can store a unit identifier referencing a unit in which the occupant is located. The referencing determines a nesting relationship between the occupant data object and unit data object 230. Each occupant data object can include an occupant identifier data field for storing an identifier of the occupant represented. Each occupant data object can include one or more attribute data fields for storing various attributes of the occupant. The attributes can include a location of the occupant. An occupant data object can include the following properties as shown in Listing 10.

Listing 10: Occupant Object Format

| Property | Required | Type | Description |
|---|---|---|---|
| OCCU_ID | Yes | String | A unique identifier for an occupant; |
| | | | an occupant occupying multiple |
| | | | levels can have multiple OCCU_IDs, |
| | | | one for each level |
| LINK_ID | Optional | String | A unique identifier for an occupant; |
| | | | an occupant occupying multiple |
| | | | levels can have a same LINK_ID |
| NAME | Yes | String | Name of an occupant. Localization |
| | | | selection can be denoted by |
| | | | appending a colon ″:″ followed by |
| | | | I18N localization code, e.g. ABC |
| | | | Store:en_US |
| CATEGORY | Yes | String | A category identifier reference |
| TAXONOMY | Optional | String | Category taxonomy name and |
| | | | version |
| LEVEL_ID | Yes | String | An identifier referencing a level |
| | | | associated with this occupant |
| PHONE | Optional | String | A primary phone number of the |
| | | | occupant. The phone number can be |
| | | | an International Telegraph Union |
| | | | Telecommunication Standardization |
| | | | Sector (ITU-T) recommended |
| | | | format, e.g., E.164 format |
| WEBSITE | Optional | String | Main website URL of the occupant. |
| HOURS | Optional | String | Weekly business schedule of the |
| | | | occupant |
| ADDRESS_ID | Optional | String | Daily business schedule of the |
| | | | occupant |
| SOURCE | Yes | String | Description of the source or sources |
| | | | used to derive the properties |
| SUITE | Optional | String | An alphanumeric suite, office, or |
| | | | store reference |

File 200 can include one or more address objects. Each address can be an address used by a venue for mailing and routing. A venue can have one or more addresses, e.g., one for the venue in the entirety, and one for every building at the venue. An address data object can include the following properties as shown in Listing 9.

Listing 9: Address Object Format

| Property | Required | Type | Description |
|---|---|---|---|
| ADDRESS_ID | Yes | String | An identifier for an address |
| ADDRESS_TYPE | Yes | String | Type of feature to which the |
| | | | address is assigned, e.g., Venue, |
| | | | Building, Unit, or Occupant |
| ADDRESS1 | Yes | String | Street address first line |
| ADDRESS2 | Optional | String | Street address second line |
| ADDRESS3 | Optional | String | Street address third line |
| ADDRESS4 | Optional | String | Street address forth line |
| PROVINCE | Optional | String | State or province for the address |
| CITY | Optional | String | City of the address |
| POSTAL | Optional | String | Postal code for the address |
| COUNTRY | Yes | String | ISO-3166-1 alpha-3 code for the |
| | | | country in which the venue is |
| | | | located |
| LEVEL_ID | Optional | String | An identifier referencing a level |
| | | | associated with this zone of |
| | | | interest |
| UNIT_ID | Optional | String | An identifier referencing a unit |
| | | | associated with this zone of |
| | | | interest |
| SOURCE | Yes | String | Description of the source or |
| | | | sources used to derive the |
| | | | properties |

In various implementations, layering of the data objects can be explicit and implicit. In the former case, features across layers can be linked through one or more foreign keys, e.g., through identifiers. For example, in some implementations, a feature, e.g., a fixture data object or a road data object can indicate that the fixture data object or road data object is related to a level data object by including an identifier of the level object. In the latter case, features across layers can be linked through spatial relationship. For example, in some implementations, a fixture data object or road data object can indicate that the fixture data object or road data object is related to a level data object by being associated with a fixture geometry that intersects a geometry of the level data object.

### Exemplary User Interface

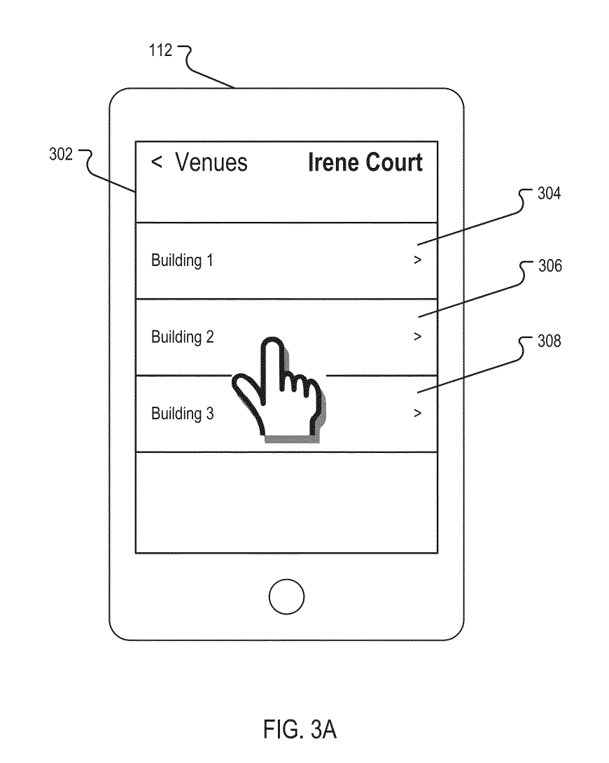

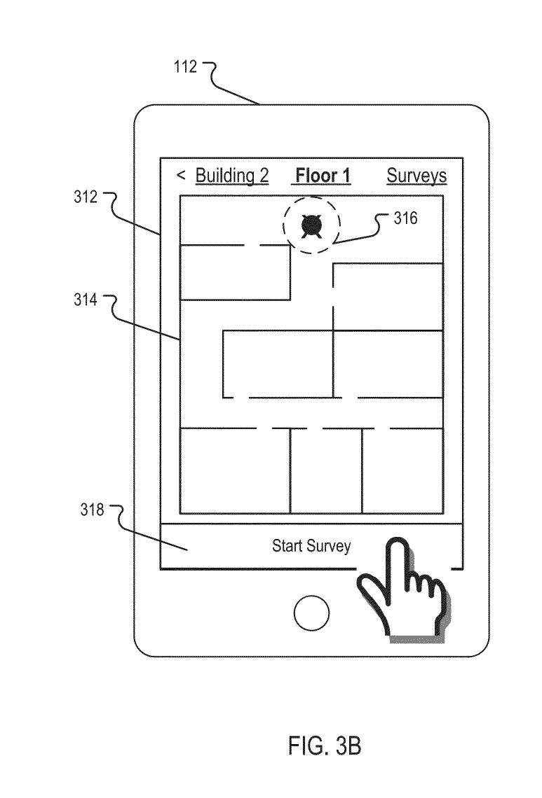

FIG. 3A illustrates an exemplary user interface 302 for selecting a building to perform location survey. User interface 302 can be displayed on sampling device 112.

Sampling device 112 can receive a user input from a surveyor to execute a survey application program. The survey application program, upon launching, can display a list of venues. Sampling device 112 may download the list from a venue service of location server 102 (of FIG. 1). The venue service can include a map pipeline for indoor venues. The list can include venue data, e.g., file 200, associated with each venue in the list. Each venue may include a group of one or more buildings. Sampling device 112 can receive a user input to select a venue, e.g., “Irene Court.” Upon selection, sampling device 112 can display user interface 302 associated with the selected venue.

User interface 302 can include user interface items 304, 306, and 308, each corresponding to a building of the selected venue. Each user interface item 304, 306, and 308 can receive a user input selecting the corresponding building to survey. Upon receiving a user input selecting one of the user interface items, e.g., user interface item 306, sampling device can display a user interface for selecting a level among multiple levels of the corresponding building.

FIG. 3B illustrates an exemplary user interface 312 for starting a location survey. Upon receiving a user selection of a building of a venue (FIG. 3A), sampling device 112 can display user interface 312. User interface 312 can include control items for selecting another building, selecting another level, and opening a previously saved survey. User interface 312 can include map 314 of the currently selected level, e.g., a first floor. Map 314 may be generated from data stored in various data fields in file 200 by sampling device 112 or by location server 102. The survey application program can preload map 314 on sampling device 112, e.g., by downloading map 314 from a venue service provided by a location server. At time of performing the survey, sampling device 112 may or may not be connected to the venue service.

Map 314 can receive a user input, e.g., a touch input, to designate a starting location for a survey. Upon receiving the user input, sampling device 112 can display marker 316 corresponding to the starting location. User interface 302 can include start survey user interface item 318. Upon receiving a user input on start survey user interface item 308, sampling device 112 can start the survey by recording environmental readings of sensors of sampling device 112 and determining motion path or paths of sampling device 112. The readings can be received signal strength indicators (RSSIs) of wireless signals from one or more wireless signal sources, e.g., wireless access points or Bluetooth Low Energy (BLE) beacons.

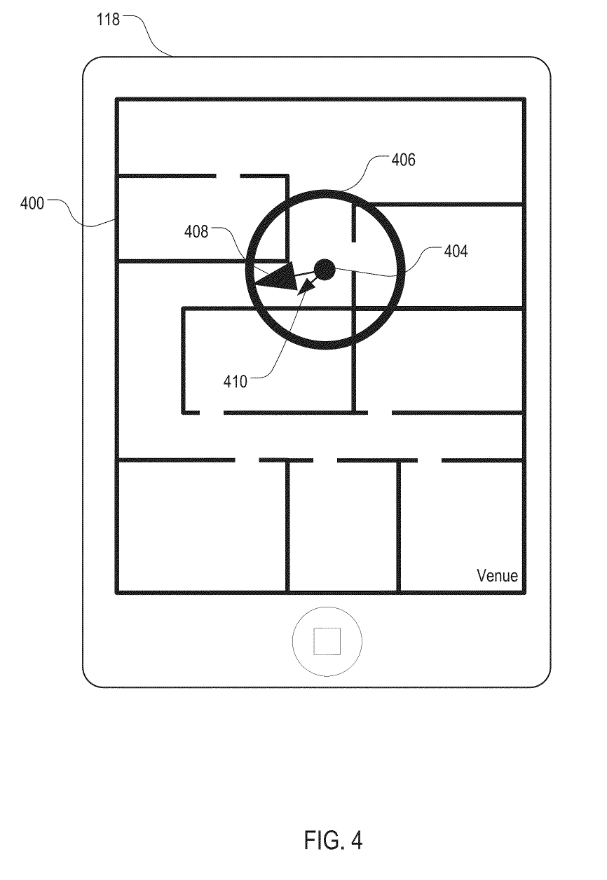

FIG. 4 illustrates an exemplary user interface for displaying an estimated location of a user device. User interface 400 can be displayed on user device 118 configured to determine an indoor location. An indoor location can be a location where signals from a satellite positioning system, e.g., global positioning system (GPS) are unavailable, not sufficiently accurate, or otherwise undesirable for determining a location. The indoor location may be a location in venue that is, for example, a building or a cave. The indoor location may include latitude and longitude coordinates.

User interface 400 can include a map of at least a portion of the venue, and location indicator 404 overlaid on the map. The map can be a map of a building or a level of a building. The map can be generated from venue data stored in file 200 (of FIG. 2). The map can be generated by location server 102 or by user device 118.

Location indicator 404 is a marker, e.g., a dot, circle, or pin, that indicates an estimated location of user device 118 in the venue. Location indicator 404 may be surrounded by accuracy indicator 406. Accuracy indicator 406 can be a circle, square, or another geometric shape. A size of accuracy indicator 406 can indicate an estimated error margin of the location of user device 118, where a larger size indicates a larger estimated error margin.

Location indicator 404 and associated accuracy indicator 406 can move as the estimated location changes, e.g., when user device 118 is carried by a user walking in the venue. As user device 118 moves, location indicator 404 can be associated with heading indicator 408. Heading indicator 408 can be an arrow pointing from location indicator 404 to an estimated heading of user device 118. User device 118 can determine the estimated location and estimated heading using measurements of signals received by user device 118 or using signals that are expected to be received but not actually received user device 118. The signals can be radio frequency (RF) signals. The estimated heading may be different from a heading determined using a gyroscope or a magnetometer, e.g., a mechanical or electronic compass, which may be subject to various interference. User device 118 can overlay marker 410 on the map. Marker 410 can indicate a heading as determined using the gyroscope or a magnetometer on the map. Marker 410 can be an arrow pointing to the heading from location indicator 404. This arrow may point to a different direction than a direction of heading indicator 408.

### Exemplary Venue Subsystem

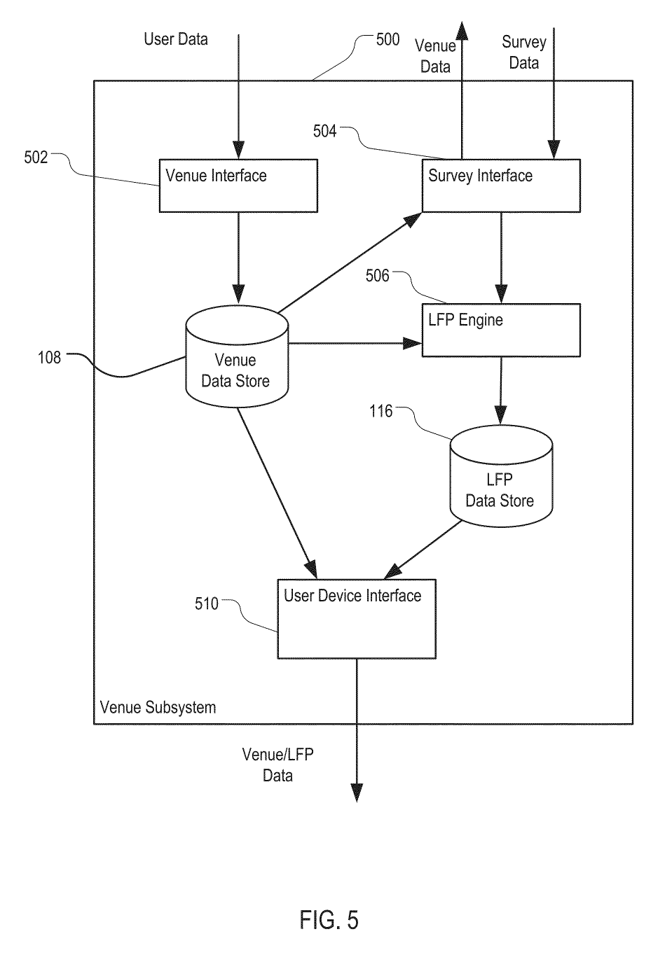

FIG. 5 is a block diagram illustrating components of an exemplary venue subsystem 500 of a location server 102. Venue subsystem 500 can include hardware or software components for providing venue service, including storing venue data, managing surveys, and providing location fingerprint data to user devices.

Venue subsystem 500 can include venue interface 502. Venue interface 502 is a component of venue subsystem 500 configured to receiving data related to venues from venue data provider computers of customers who provide the data for surveying the venues. The data can be venue data consistent with the format of file 200 as described in reference to FIG. 2, or in another format. Venue interface 502 can convert the received data into venue data if the received data is in another format. Venue interface 502 can store the venue data in venue data store 108.

Venue subsystem 500 can include survey interface 504. Survey interface 504 can provide venue data stored in venue data store 108 to one or more sampling devices to conduct the survey. In some implementations, survey interface 504 can generate a map of each venue, each building of the venue, each level in the building, each unit on each level, each POI in the buildings, each occupant in the building, and each zone of interest in the building, and provide the map to the sampling devices for surveying.

Survey interface 504 can receive survey data from the sampling devices, in real time or in batch. Survey interface 504 can provide the survey data to location fingerprint engine 506 for further processing. Location fingerprint engine 506 is a component of venue subsystem 500 configured to generate location fingerprint data from survey data received from survey interface 504. Generating location fingerprint data can include stitching surveys performed on a venue, building, or level by multiple sampling devices and interpolating or extrapolating expected sensor readings for locations in a venue that is not surveyed. Venue subsystem 500 can store the location fingerprint data in location fingerprint data store 116.

Venue subsystem 500 can include user device interface 510. User device interface 510 is a component of venue subsystem 500 configured to receive a request for venue data and location fingerprint data, and provide the venue data stored in venue data store 108 and location fingerprint data stored in location fingerprint data store 116 to the requesting user device. In some implementations, user device interface 510 can generate a map of a venue, including a map of each building and each level of each building, and provide the map to the user device.

### Exemplary Procedures

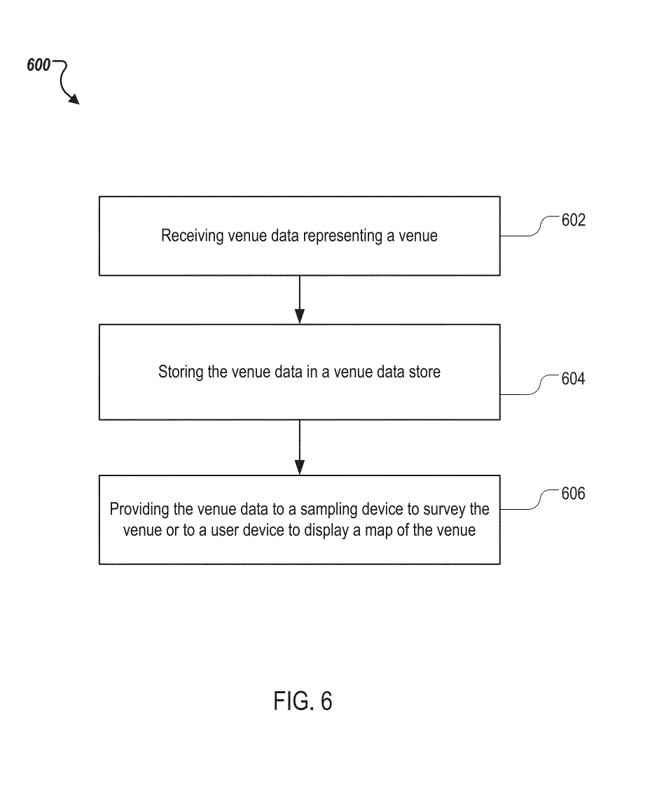

FIG. 6A is a flowchart of an exemplary process 600 of storing venue information. Process 600 can be performed by a location server including one or more computer processors, e.g., location server 102 of FIG. 1.

The location server can receive (602), from one or more venue data provider computers, venue data representing a venue. The venue data can include one or more files. The files can be in an American Standard Code for Information Interchange (ASCII) format or compressed binary format. Each file can include a series of one or more data object.

The location can store (604) the venue data in a venue data store as a venue data file, e.g., file 200 of FIG. 2. The venue data file can include nested data objects. The nested data object includes a venue data object and, optionally, one or more building data objects. The venue data object is a top layer object of the nested data objects representing geographic attributes and other attributes of the venue. The venue data object includes a venue identifier data field storing a venue identifier identifying the venue. The venue data object includes a venue name data field storing a name of the venue. The venue data object includes a venue geometry data field storing a closed polygon representation of a geometry of the venue. The venue data object can include a country code data field storing a code of a country in which the venue is located.

Each building data object is a second layer object of the nested data objects representing geographic attributes and other attributes of a respective building located at the venue. Each building data object can include a building identifier data field storing a building identifier identifying the respective building. Each building data object can include a building address data field storing a street address of the respective building. Each building data object can include a building geometry data field storing a closed polygon representation of a geometry of the respective building. Each building data object can include a primary building data field storing a code indicating whether the respective building is a primary building of the venue. In some implementations, each building data object can include a venue identifier reference data field storing the venue identifier indicating that the respective building data object is nested in the venue data object in the second layer that is one level below the top layer. The venue identifier stored in the venue identifier reference data field can indicate that the respective building is a portion of the venue. In some implementations, each closed polygon representation of a building intersects the closed polygon representation of a geometry of the venue. The intersection between the polygons indicates each building data object is the second layer object.

The venue data file can include one or more level data objects. Each level data object is a third layer object of the nested data objects and represents geographic attributes and other attributes of a respective level of a building. Each level data object can include a level identifier data field storing an identifier of the respective level. Each level data object can include a level geometry data field storing a closed polygon representation of a geometry of the respective level. Each level data object can include a level number data field storing a z-level order of the respective level. Each level data object can include a building identifier data reference field storing a building identifier of the one or more building identifiers. The building identifier can indicate that a respective level data object is nested in the respective building data object in the third layer that is one level below the second layer, and indicate that the respective level is a portion of the respective building.

The venue data file can include one or more unit data objects. Each unit data object is a fourth layer object of the nested data objects and represents geographic attributes and other attributes of a unit located at a respective level. Each unit data object can include a unit identifier data field storing an identifier of the respective unit. Each unit data object can include a unit name data field storing a name of the respective unit. Each unit data object can include a unit geometry data field storing a closed polygon representation of a geometry of the respective unit. Each unit data object can include a unit number data field storing an alphanumeric number of the respective unit. Each unit data object can include a level identifier reference data field for storing a level identifier of the one or more level identifiers, the level identifier indicating that a respective unit data object is nested in the respective level data object in the fourth layer that is one level below the third layer, and indicating that the respective unit is located at the respective level.

The venue data file can include one or more point data objects. Each point data object is a fifth layer object of the nested data objects and represents geographic attributes and other attributes of a respective point located at the respective unit. Each point data object can include a point identifier data field storing an identifier of the respective point. Each point data object can include a point name data field storing a name of the respective point. Each point data object can include a point location data field storing geographic coordinates of a location of the respective point. Each point data object can include and at least one of a unit identifier reference data field or a level identifier reference data field. The unit identifier reference data field can store a unit identifier of the one or more unit identifiers. The unit identifier indicates that a respective point data object is nested in the respective unit data object in the fifth layer and indicates that the respective point is located at the respective unit. The level identifier reference data field can store a level identifier of the one or more level identifiers. The level identifier indicates that a respective point data object is nested in the respective level data object in the fifth layer, and indicates that the respective point is located at the respective level.

The venue data file can include one or more occupant data objects. Each occupant data object is a sixth layer object of the nested data objects and represents geographic attributes and other attributes of a respective occupant located at the respective unit. Each occupant data object can include an occupant identifier data field storing an identifier of the respective occupant. Each occupant data object can include an occupant name data field storing a name of the respective occupant. Each occupant data object can include an occupant location data field storing geographic coordinates of a location of the respective occupant. Each occupant data object can include a unit identifier data reference field for storing a unit identifier of the one or more unit identifiers. The unit identifier can indicate that a respective occupant data object is nested in the respective unit data object in the sixth layer, and indicates that the respective occupant is located at the respective unit.

Each closed polygon representation is a geographic representation of a geometric shape of a respective venue, building, level, unit, or zone of interest. The nested data objects are JavaScript object notation (JSON) data objects.

The location server can provide (606) the venue data to a sampling device for surveying the venue, to a user device for displaying a map of the venue or for determining a location of the user device in the venue.

### Exemplary System Architecture

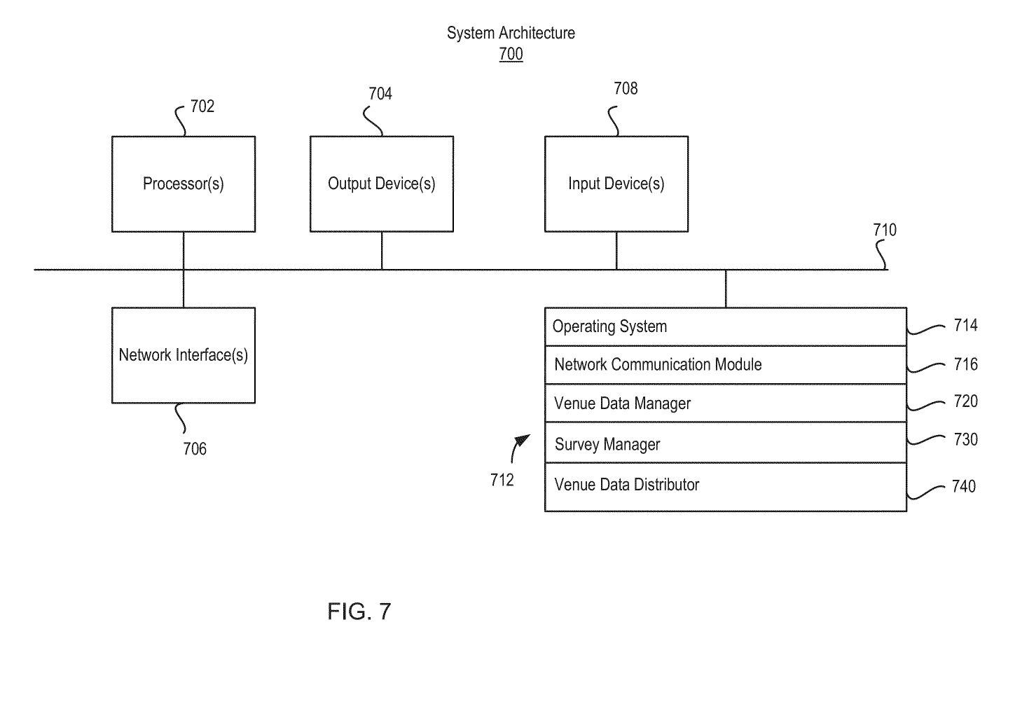

FIG. 7 is a block diagram of an exemplary system architecture for implementing the features and operations of FIGS. 1-6. Other architectures are possible, including architectures with more or fewer components. In some implementations, architecture 700 includes one or more processors 702 (e.g., dual-core Intel® Xeon® Processors), one or more output devices 704 (e.g., LCD), one or more network interfaces 706, one or more input devices 708 (e.g., mouse, keyboard, touch-sensitive display) and one or more computer-readable mediums 712 (e.g., RAM, ROM, SDRAM, hard disk, optical disk, flash memory, etc.). These components can exchange communications and data over one or more communication channels 710 (e.g., buses), which can utilize various hardware and software for facilitating the transfer of data and control signals between components.

The term “computer-readable medium” refers to a medium that participates in providing instructions to processor 702 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 712 can further include operating system 714 (e.g., a Linux® operating system), network communication module 716, venue data manager 720, survey manager 730, and venue data distributor 740. Operating system 714 can be multi-user, multiprocessing, multitasking, multithreading, real time, etc. Operating system 714 performs basic tasks, including but not limited to: recognizing input from and providing output to devices 708; keeping track and managing files and directories on computer-readable mediums 712 (e.g., memory or a storage device); controlling peripheral devices; and managing traffic on the one or more communication channels 710. Network communications module 716 includes various components for establishing and maintaining network connections (e.g., software for implementing communication protocols, such as TCP/IP, HTTP, etc.).

Venue data manager 720 can include computer instructions that, when executed, cause processor 702 to perform operations of receiving and storing venue data in one or more files. Survey manager 730 can include computer instructions that, when executed, cause processor 702 to provide survey instructions and venue data or maps generated based on the venue data to a sampling device and receive survey data from the sampling device. Venue data distributor 740 can include computer instructions that, when executed, cause processor 702 to respond a request from a user device, including sending venue data or maps generated based on the venue data to the requesting mobile device.

Architecture 700 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by one or more processors, venue data representing a venue, the venue data comprising a file including nested data objects, the nested data object including a venue data object and one or more building data objects; and
providing the venue data to a device for surveying the venue, for displaying a map of the venue, or for determining a location of the device in the venue, wherein:
the venue data object is a top layer object of the nested data objects representing attributes of the venue, the venue data object comprising: a venue identifier data field storing a venue identifier identifying the venue, a venue name data field storing a name of the venue, and a venue geometry data field storing a closed polygon representation of a geometry of the venue, and wherein:
each building data object is a second layer object of the nested data objects representing attributes of a respective building located at the venue, each building data object comprising: a building identifier data field storing a building identifier identifying the respective building, a building address data field storing an index to a street address of the respective building, a building geometry data field storing a closed polygon representation of a geometry of the respective building, wherein each closed polygon representation of the respective building intersects the closed polygon representation of a geometry of the venue, and wherein intersections between the polygons indicate each building data object is the second layer object.

2. The method of claim 1, wherein the file includes one or more level data objects, and wherein:
each level data object is a third layer object of the nested data objects and represents geographic attributes of a respective level of a building, and
each level data object comprises:
a level identifier data field storing an identifier of the respective level;
a level geometry data field storing a closed polygon representation of a geometry of the respective level;
a level number data field storing a z-level order of the respective level; and
a building identifier data reference field storing a building identifier of the one or more building identifiers, the building identifier indicating that a respective level data object is nested in the respective building data object in the third layer that is one level below the second layer and indicating that the respective level is a portion of the respective building.

3. The method of claim 2, wherein the file includes one or more unit data objects, and wherein:
each unit data object is a fourth layer object of the nested data objects and represents geographic attributes of a unit located at a respective level, and
each unit data object comprises:
a unit identifier data field storing an identifier of the respective unit;
a unit name data field storing a name of the respective unit;
a unit geometry data field storing a closed polygon representation of a geometry of the respective unit;
a unit number data field storing an alphanumeric number of the respective unit; and
a level identifier reference data field for storing a level identifier of the one or more level identifiers, the level identifier indicating that a respective unit data object is nested in the respective level data object in the fourth layer that is one level below the third layer and indicating that the respective unit is located at the respective level.

4. The method of claim 3, wherein the file includes one or more point data objects, and wherein:
each point data object is a fifth layer object of the nested data objects and represents attributes of a respective point located at the respective unit, and
each point data object comprises:
a point identifier data field storing an identifier of the respective point;
a point name data field storing a name of the respective point;
a point location data field storing geographic coordinates of a location of the respective point; and at least one of:
a unit identifier reference data field for storing a unit identifier of the one or more unit identifiers, the unit identifier indicating that a respective point data object is nested in the respective unit data object in the fifth layer and indicating that the respective point is located at the respective unit, or
a level identifier reference data field for storing a level identifier of the one or more level identifiers, the level identifier indicating that a respective point data object is nested in the respective level data object in the fifth layer and indicating that the respective point is located at the respective level.

5. The method of claim 4, wherein the file includes one or more occupant data objects, and wherein:
each occupant data object is a sixth layer object of the nested data objects and represents attributes of a respective occupant located at the respective unit, each occupant data object comprising:
an occupant identifier data field storing an identifier of the respective occupant;
an occupant name data field storing a name of the respective occupant;
an occupant location data field storing geographic coordinates of a location of the respective occupant; and
a unit identifier reference data field for storing a unit identifier of the one or more unit identifiers, the unit identifier indicating that a respective occupant data object is nested in the respective unit data object in the sixth layer and indicating that the respective occupant is located at the respective unit.

6. The method of claim 5, wherein each closed polygon representation is a world geodetic system (WGS) representation of a geometric shape of a respective venue, building, level, or unit.

7. The method of claim 1, wherein the nested data objects are JavaScript object notation (JSON) data objects.

8. The method of claim 1, wherein the venue data object includes an address data field storing an index to an address of the venue.

9. A method, comprising:
receiving, by one or more processors, venue data representing a venue, the venue data comprising a file including nested data objects, the nested data objects including a venue data object and one or more building data objects; and
providing the venue data to a device for surveying the venue, for displaying a map of the venue, or for determining a location of the device in the venue, wherein:
the venue data object is a top layer object of the nested data objects representing attributes of the venue, the venue data object comprising: a venue identifier data field storing a venue identifier identifying the venue, a venue name data field storing a name of the venue, and a venue geometry data field storing a closed polygon representation of a geometry of the venue, and wherein:
each building data object is a second layer object of the nested data objects representing attributes of a respective building located at the venue, each building data object comprising: a building identifier data field storing a building identifier identifying the respective building, a building address data field storing an index to a street address of the respective building, a building geometry data field storing a closed polygon representation of a geometry of the respective building and a venue identifier reference data field storing the venue identifier indicating that the respective building data object is nested in the venue data object in the second layer that is one level below the top layer, and indicating that the respective building is a portion of the venue.

10. A system comprising:
one or more processors; and
a storage device storing computer instructions operable to cause the one or more processors to perform operations comprising:
receiving, by one or more processors, venue data representing a venue, the venue data comprising a file including nested data objects, the nested data object including a venue data object and one or more building data objects; and
providing the venue data to a device for surveying the venue, for displaying a map of the venue, or for determining a location of the device in the venue, wherein:
the venue data object is a top layer object of the nested data objects representing attributes of the venue, the venue data object comprising: a venue identifier data field storing a venue identifier identifying the venue, a venue name data field storing a name of the venue, and a venue geometry data field storing a closed polygon representation of a geometry of the venue, and wherein:
each building data object is a second layer object of the nested data objects representing attributes of a respective building located at the venue, each building data object comprising: a building identifier data field storing a building identifier identifying the respective building, a building address data field storing an index to a street address of the respective building, a building geometry data field storing a closed polygon representation of a geometry of the respective building, wherein each closed polygon representation of the respective building intersects the closed polygon representation of a geometry of the venue, and wherein intersections between the polygons indicate each building data object is the second layer object.

11. The system of claim 10, wherein the file includes one or more level data objects, and wherein:
each level data object is a third layer object of the nested data objects and represents geographic attributes of a respective level of a building, and
each level data object comprises:
a level identifier data field storing an identifier of the respective level;
a level geometry data field storing a closed polygon representation of a geometry of the respective level;
a level number data field storing a z-level order of the respective level; and
a building identifier data reference field storing a building identifier of the one or more building identifiers, the building identifier indicating that a respective level data object is nested in the respective building data object in the third layer that is one level below the second layer and indicating that the respective level is a portion of the respective building.

12. The system of claim 11, wherein the file includes one or more unit data objects, and wherein:
each unit data object is a fourth layer object of the nested data objects and represents geographic attributes of a unit located at a respective level, and
each unit data object comprises:
a unit identifier data field storing an identifier of the respective unit;
a unit name data field storing a name of the respective unit;
a unit geometry data field storing a closed polygon representation of a geometry of the respective unit;
a unit number data field storing an alphanumeric number of the respective unit; and
a level identifier reference data field for storing a level identifier of the one or more level identifiers, the level identifier indicating that a respective unit data object is nested in the respective level data object in the fourth layer that is one level below the third layer and indicating that the respective unit is located at the respective level.

13. The system of claim 12, wherein the file includes one or more point data objects, and wherein:
each point data object is a fifth layer object of the nested data objects and represents attributes of a respective point located at the respective unit, and
each point data object comprises:
a point identifier data field storing an identifier of the respective point;
a point name data field storing a name of the respective point;
a point location data field storing geographic coordinates of a location of the respective point; and at least one of:
a unit identifier reference data field for storing a unit identifier of the one or more unit identifiers, the unit identifier indicating that a respective point data object is nested in the respective unit data object in the fifth layer and indicating that the respective point is located at the respective unit, or
a level identifier reference data field for storing a level identifier of the one or more level identifiers, the level identifier indicating that a respective point data object is nested in the respective level data object in the fifth layer and indicating that the respective point is located at the respective level.

14. The system of claim 13, wherein the file includes one or more occupant data objects, and wherein:
each occupant data object is a sixth layer object of the nested data objects and represents attributes of a respective occupant located at the respective unit, each occupant data object comprising:
an occupant identifier data field storing an identifier of the respective occupant;
an occupant name data field storing a name of the respective occupant;
an occupant location data field storing geographic coordinates of a location of the respective occupant; and
a unit identifier reference data field for storing a unit identifier of the one or more unit identifiers, the unit identifier indicating that a respective occupant data object is nested in the respective unit data object in the sixth layer and indicating that the respective occupant is located at the respective unit.

15. The system of claim 10, wherein the nested data objects are GeoJSON data objects.

16. A non-transitory storage device storing computer instructions operable to cause one or more processors to perform operations comprising:
receiving, by one or more processors, venue data representing a venue, the venue data comprising a file including nested data objects, the nested data object including a venue data object and one or more building data objects; and
providing the venue data to a device for surveying the venue, for displaying a map of the venue, or for determining a location of the device in the venue, wherein:
the venue data object is a top layer object of the nested data objects representing attributes of the venue, the venue data object comprising: a venue identifier data field storing a venue identifier identifying the venue, a venue name data field storing a name of the venue, and a venue geometry data field storing a closed polygon representation of a geometry of the venue, and wherein:
each building data object is a second layer object of the nested data objects representing attributes of a respective building located at the venue, each building data object comprising: a building identifier data field storing a building identifier identifying the respective building, a building address data field storing an index to a street address of the respective building, a building geometry data field storing a closed polygon representation of a geometry of the respective building, wherein each closed polygon representation of the respective building intersects the closed polygon representation of a geometry of the venue, and wherein intersections between the polygons indicate each building data object is the second layer object.

17. The non-transitory storage device of claim 16, wherein the file includes one or more level data objects, and wherein:
each level data object is a third layer object of the nested data objects and represents geographic attributes of a respective level of a building, and
each level data object comprises:
a level identifier data field storing an identifier of the respective level;
a level geometry data field storing a closed polygon representation of a geometry of the respective level;
a level number data field storing a z-level order of the respective level; and
a building identifier data reference field storing a building identifier of the one or more building identifiers, the building identifier indicating that a respective level data object is nested in the respective building data object in the third layer that is one level below the second layer and indicating that the respective level is a portion of the respective building.

18. The non-transitory storage device of claim 17, wherein the file includes one or more unit data objects, and wherein:
each unit data object is a fourth layer object of the nested data objects and represents geographic attributes of a unit located at a respective level, and
each unit data object comprises:
a unit identifier data field storing an identifier of the respective unit;
a unit name data field storing a name of the respective unit;
a unit geometry data field storing a closed polygon representation of a geometry of the respective unit;
a unit number data field storing an alphanumeric number of the respective unit; and
a level identifier reference data field for storing a level identifier of the one or more level identifiers, the level identifier indicating that a respective unit data object is nested in the respective level data object in the fourth layer that is one level below the third layer and indicating that the respective unit is located at the respective level.

19. The non-transitory storage device of claim 18, wherein the file includes one or more point data objects, and wherein:
each point data object is a fifth layer object of the nested data objects and represents attributes of a respective point located at the respective unit, and
each point data object comprises:
a point identifier data field storing an identifier of the respective point;
a point name data field storing a name of the respective point;
a point location data field storing geographic coordinates of a location of the respective point; and at least one of:
a unit identifier reference data field for storing a unit identifier of the one or more unit identifiers, the unit identifier indicating that a respective point data object is nested in the respective unit data object in the fifth layer and indicating that the respective point is located at the respective unit, or
a level identifier reference data field for storing a level identifier of the one or more level identifiers, the level identifier indicating that a respective point data object is nested in the respective level data object in the fifth layer and indicating that the respective point is located at the respective level.

20. The non-transitory storage device of claim 19, wherein the file includes one or more occupant data objects, and wherein:
each occupant data object is a sixth layer object of the nested data objects and represents attributes of a respective occupant located at the respective unit, each occupant data object comprising:
an occupant identifier data field storing an identifier of the respective occupant;
an occupant name data field storing a name of the respective occupant;
an occupant location data field storing geographic coordinates of a location of the respective occupant; and
a unit identifier reference data field for storing a unit identifier of the one or more unit identifiers, the unit identifier indicating that a respective occupant data object is nested in the respective unit data object in the sixth layer and indicating that the respective occupant is located at the respective unit.

21. The non-transitory storage device of claim 16, wherein the nested data objects are GeoJSON data objects.

22. The non-transitory storage device of claim 16, wherein the venue data object includes an address data field storing an index to an address of the venue.
